(19) United States
(12) Patent Application Publication
(10) Pub. No.: US 2010/0241716 A1
(43) Pub. Date: Sep. 23, 2010

(54) System for interconnecting manifold entities across a real-time Meshed Information Exchange network

(76) Inventor: Tayo Dare Akadiri, Aldie, VA (US)

Correspondence Address: Tayo Akadiri, 42116 Tanzanite Terrace, Aldie, VA, 20105, US

(21) Appl. No.: 12/726,334

(22) Filed: Mar. 17, 2010

Related U.S. Application Data
(60) Provisional application No. 61/161,064, filed on Mar. 17, 2009.

(51) Int. Cl. G06F 15/16

(52) U.S. Cl. 709/206; 709/245; 709/230

(57) ABSTRACT

A meshed information exchange network of uniquely addressable nodes—where any node in that network may act as a client or a server and independently maintain, expose or transfer entity attributes (consisting of any kind of data or media). Each node may independently and simultaneously interact with a multiplicity of other nodes to communicate, process or distribute any data over any protocol—such that any person, consumer appliance, product, service, computer, device, machine or other entities may instantly interact, share, process, consume, distribute or exchange any kind of data with pluralities of any other kind of entities in real-time across networks and the Internet. The invention enables the creation of a universally cross-linked real-time information-space of structured data, instrumentation and services

This application claims benefit to: Provisional Application 61/161,064, filed Mar. 17^{th} , 2009

### BACKGROUND

Communications systems like Email allow people to transmit information over the Internet. A system like email is intended to work over one network protocol (SMTP/POP or IMAP) and to transmit data to one or many receivers over that single protocol. Furthermore, email systems expose a user's private email identity in such a way that there is a near-fatal flaw of un-mediated access (spam). Email is intended for conveying free form text or media attachments. Email has no ability to model and appropriately process structured data for any type of business entity.

All the above deficiencies that apply to Email also apply to web servers, and to web sites. Web sites are intended for the distribution of HTML pages and other content, in a point-to-point fashion over one protocol-HTTP-only. Other than links for downloading content, web servers rely on Hyper Text links that need human user interaction to connect to one another. Web servers do not coordinate multi-step complex flows of information between servers. In addition, web sites have a very limited ability to express semantic meaning in their content. Furthermore, methods for subscribing to information over the web (like RSS) rely on pushing identical information to many individuals over a dedicated protocol—and do not support the flexibility needed to create a general-purpose semantic information-grid.

There are micro-blogging and social networking systems like Twitter or Facebook that broadcast messages from one user to many via the web, email, or mobile SMS. A system like micro-blogging or social networking transmits limited text messages. These systems centralize the receipt and re-distribution of messages at a central server(s); it is not a mesh network wherein the processing and/or distribution of data can be performed on any desired client host, and each client host is itself aware of how to connect directly to others. Micro-blogging services do not transmit structured or complex data like business forms, digital content, software, complex messages, etc. Prior art like this does not include configurable nodes that process and re-route the information in-transit. These services do not use hierarchical data that that can model any business domain (medical, automotive, social networking, device configuration, etc). Prior art like this does not support the concept of configurable intelligence at each client. Finally, micro-blogging is not a method for creating, exposing and invoking arbitrary networked services (requests for digital content, Identity services, etc.) wherein each client may return complex responses, modify and process data, or forward responses to other services and destinations.

There are business software systems called Enterprise Service Buses (ESBs) that function as integration infrastructure within businesses for enabling service oriented architecture integration between the distributed applications of the business. A deficiency in these systems is that an ESB is a centralized junction limited to interconnecting applications within an enterprise. This design does not function well for peer-to-peer communications involving millions of participants (not only applications, but people and appliances and consumer devices) over a wide area network such as the Internet. This deficiency also manifests in the fact that the ESB represents a single point of failure. Another deficiency in the ESB is that it relies on a standardized enterprise messaging model, and therefore does not function as a carrier of heterogeneous messages. Because ESBs are designed to run as middle-ware on enterprise-grade servers, another deficiency of ESBs it that they can not run on consumer appliances such as smart-phones, or tablet computers, or set-top boxes, or medical devices with limited memory and resources.

Another common deficiency of the prior art is that there is no way for the messaging and data emanating from any of a multiplicity of distributed heterogeneous data sources (different devices, people, appliances and applications) to be automatically mixed or combined in real-time with the output of any other remote data source into new hybrid information that can itself become a data source in a mesh network.

What would be useful is a universal meshed information exchange (MIX) network of uniquely addressable nodes—where any node in that network may act as a client or a server and independently maintain, expose or transfer entity attributes (consisting of any kind of data or media) and also may independently interact with a multiplicity of other nodes to communicate, process or distribute any data over any protocol—such that any individual person, consumer appliance, service, computer, device or other entities (represented by such a node with a unique address and a characteristic state) may instantly interact, share, process, consume, distribute or exchange any kind of data with pluralities of any other kind of entities in real-time. The invention enables the creation of a universally cross-linked information-space of structured data and services

### SUMMARY

In an embodiment, a meshed information exchange (MIX) comprises of independent, interconnected nodes, called MIX nodes. Each node in the MIX network represents a person or a device or a consumer appliance or a service or organization, etc. A node can run in very compact form, inside appliances or mobile devices, or consumer products for example. Each node can (in real-time) interact, monitor, change, supply, consume or exchange real-time data with any or any subset of other nodes.

In an embodiment, each meshed information exchange (MIX) node has a unique identifier, at least one receiving adapter by which it can receive data, has processing instructions, has entity attributes that model the state of an entity (a person, consumer appliance, service, device, etc) that the MIX node represents, has capabilities-and-resources definition that describe the services and data that the node can provide, has a general storage area to hold data, has at least one data delivery adapter to send data, and has node meta-data that includes the address of other MIX nodes or network endpoints.

In an embodiment, the unique identifier of a meshed information exchange (MIX) node is in the form of a Uniform Resource Locator (URI) or other standardized resource identifier such as the Extensible Resource Identifier (XRI) so that other suppliers or consumers of data/services may address the MIX Node with that identifier. Some examples of MIX node URIs include:

http://fairfaLgov/FairfaxCounty/SmartFiectricftyGrid/PowerStation19
http://medicare.net/UsitedHealthCarehlohnSmittilHomeMonitoring/BloodSugar
https://minnesh.net/alice.smith
These URLs may be used to identify a node and to send data into that node using HTTP/HTTPs protocol.

The meta-data of a meshed information exchange node may include distribution information such as other node addresses or network endpoints sufficient to independently transfer information on behalf of the mesh network. The meta-data may also include filtering rules, to selectively execute the processing instructions. The meta-data may also include access rules to access the node's capabilities and resources. The meta-data may also include identity information and credentials sufficient to securely connect to other nodes and endpoints, or to sign or encrypt/decrypt data. The meta-data may include any information that helps to modify the node's behavior.

In an embodiment, the meta-data of a meshed information exchange (MIX) node may be updated by data received from another MIX node, or another network endpoint.

The processing instructions of a meshed information exchange node enable it to execute processing tasks. These tasks may include the execution of rules, service-fulfillment, commercial transactions, data processing, data forwarding, or any functionality that can be implemented via a set of processing instructions. The processing instructions may integrate with, or be a part of any software running on the device hosting the node, or accessible by the node.

In an embodiment, the processing instructions belonging to a meshed information exchange (MIX) node may be updated by data received from another MIX node, or another network endpoint.

In an embodiment, the processing instructions are in the form of a standard scripted language such as PERL, PYTHON, or scripted or interpreted languages that can be executed with the assistance of a standard script-runner, interpreter or virtual machine.

In another embodiment, the processing instructions are in the form of a network-downloadable language such as Java. In this embodiment, the processing instructions can be updated by using standard mechanisms such as Java class loading.

In an embodiment, the processing instructions belonging to a meshed information exchange (MIX) node may be conditionally executed depending on the meta-data, or the entity attributes, or data in the storage area of the node.

The entity attributes of a meshed information exchange (MDC) node are data structured according to any schema that models the type of entity that the node represents, such as a person, a consumer appliance, a service, a device or other distinct entity. These attributes change as the state of the entity changes, to represent key aspects of the state of the entity.

In an embodiment, the entity attributes are in the form of structured data standards such as XML, or XHTML, such that XML elements and attributes model the state.

In an embodiment, the entity attributes belonging to a meshed information exchange (MDC) node may be updated by data received from another MIX node, or another network endpoint.

In an embodiment, the entity attributes belonging to a meshed information exchange (MIX) node may be requested by, and transmitted in part or in full to another MIX node, or another network endpoint.

The capabilities-and-resource definition of a meshed information exchange (MIX) node contains information that describes what type of entity the node represents, what information it provides, what capabilities it supports, services it offers, and other information about the node that may be discovered by others.

In an embodiment, the capabilities-and-resource definition may be requested by, and transmitted in part or in full to another MIX node, or another network endpoint.

In an embodiment, the capabilities-and-resource definition may be defined in an Internet-standard resource definition format such as XRDS.

The general storage area of a meshed information exchange (MIX) node may be used to hold any data that a MIX node owns, generates, or receives.

In an embodiment, the general storage area of a meshed information exchange (MIX) node is used by the node's processing instructions to hold data that is received from other MIX nodes for the purpose of combining multiple sources of data into new data of additional value.

In another embodiment, the general storage area of a meshed information exchange (MIX) node is used by the node's processing instructions to hold data that the node intends to transmit to another MIX node or network endpoint, for timing purposes, or if the recipient is temporarily unreachable, or unavailable—to achieve timing synchronization or fault tolerance in the mesh network.

In another embodiment, the general storage area of a meshed information exchange (MIX) node is used by the node's processing instructions to hold data that may be later requested by another MIX node or network endpoint.

In an embodiment, the general storage area of a meshed information exchange (MIX) node may be updated by data received from another MIX node, or another network endpoint.

In an embodiment, a meshed information exchange (MIX) node may receive data addressed directly to it and perform some processing, or alter the data, or alter its own representational state, or provide some data in response.

In another embodiment, a node may receive data addressed to it and perform some processing, or alter the data, or alter its own representational state, and then forward the data onto one or more MIX nodes or network endpoints based on distribution information in the data, or in the MIX node's own meta-data.

Data addressed to a meshed information exchange (MIX) node may be processed in accordance with access rules in the meta-data of the node. This allows the entity that the node represents to selectively manage access to the MIX node's resources and data.

In an embodiment, a node may receive data addressed to another node and route the data one step closer via the most appropriate recipient using its local knowledge of the mesh network in a distribution table or meta-data,. This process will continue until the data reaches the destination node.

In an embodiment, the data that a meshed information exchange node receives or transmits may consist of a message containing meta-data and a payload. The meta-data may include payload description, node identification, security, addressing/distribution information and other information useful to the secure and successful delivery or fulfillment of the data interaction. The payload may be any kind of structured or unstructured data, of any type or length.

In an embodiment, the data that a meshed information exchange node receives or transmits is in the form of a structured data standard such as XML, or XHTML, such that the elements and attributes model the meta-data and the payload.

In an embodiment, the data that a meshed information exchange node receives or transmits may consist of a binary stream such as multimedia data, or other streamed data.

In an embodiment, other network clients, servers or devices using their own protocols (web, email, instant messaging, text messaging, media center, set-top-box, etc) may use adapters to connect to the meshed information exchange (MIX) network, and thus to send data into MIX nodes, or to receive data from MIX nodes, or to interact with or be instrumented by MIX nodes.

### DESCRIPTION OF THE DRAWINGS

FIG. 1 illustrates a block diagram of an embodiment illustrating the installation of of a meshed information exchange node within a computer processor associated to an entity.

FIG. 2 illustrates a block diagram of an embodiment illustrating logical elements of a meshed information exchange node.

FIG. 3 illustrates a flow of a communication according to an embodiment

FIG. 4 illustrates a flow of a communication according to an embodiment.

FIG. 5 illustrates an embodiment in which multiple entity types are integrated via meshed information exchange nodes.

### DETAILED DESCRIPTION

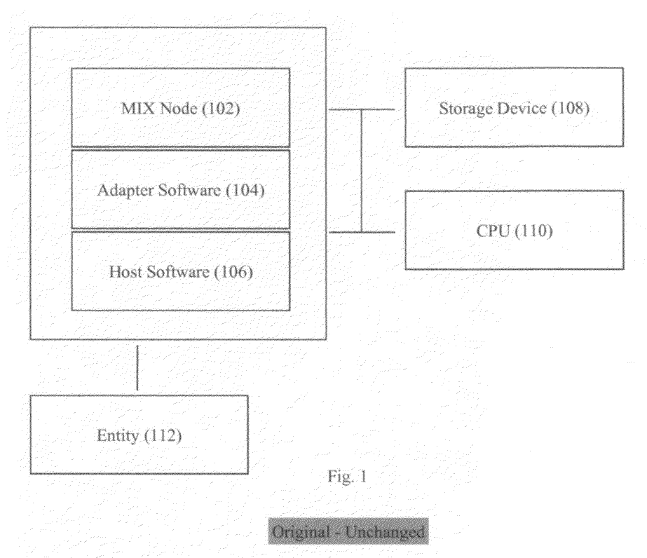

FIG. 1 illustrates a block diagram of an embodiment illustrating the installation of of a meshed information exchange (MIX) node 102 within a computer processor 110 associated to an entity 112. In this embodiment, the MIX node 102 is connected to host software 106 by adapter software 104. Entity 112 is associated with the MIX node.

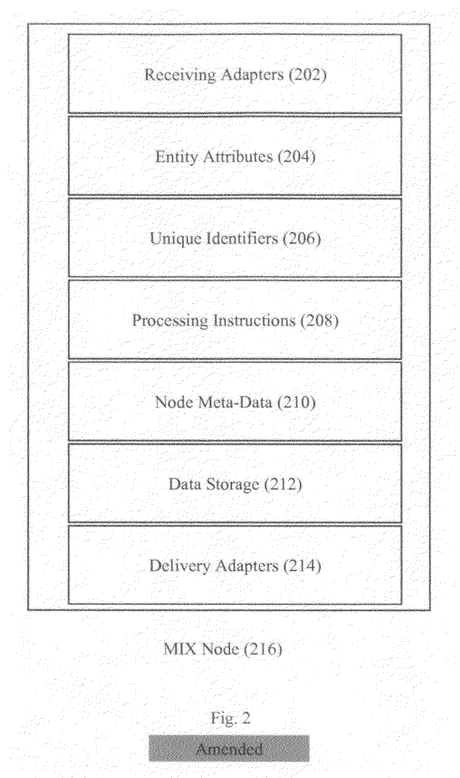

FIG. 2 illustrates a block diagram of an embodiment illustrating logical elements of a meshed information exchange (MIX) node 216. Receiving adapters 202 convey data packages into the node's processing instructions 208. Entity attributes 204 model and store the state of an entity that the node is associated with. Node meta-data 210 configures the behavior of the node as it processes or emits data packages. Data storage 212 is used by the node to hold information generated in the node, or received by the node. Delivery adapters 214 transmit data packages to distribution destinations configured in node meta-data 210.

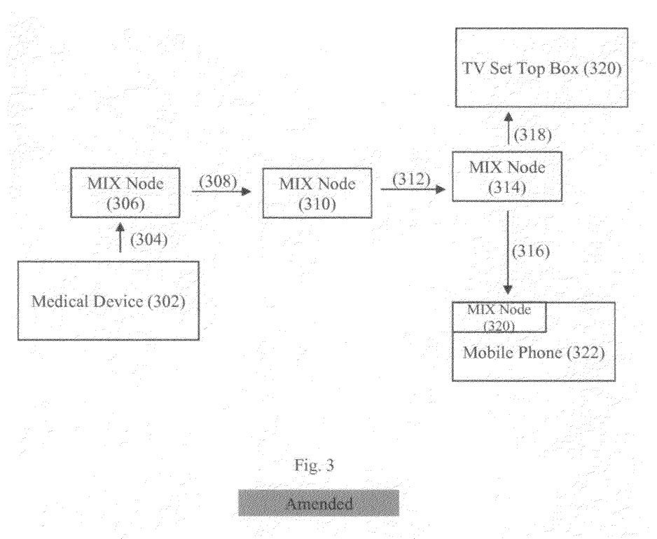

FIG. 3 illustrates a flow of a communication according to an embodiment. Medical device 302 generates a critical alert 304. MIX node 306 that is associated with the medical device acquires the alert through adapter software integrating MIX node 306 to medical device 302. MIX node 306 executes processing instructions, using node meta-data to determine the distribution instructions for that type of alert. MIX node 306 generates an alert message data package 308 and distributes to MIX node 310 that is associated to a health care professional's official profile. MIX node 310 executes processing instructions, using node meta-data to determine the distribution instructions for that type of alert. MIX node 310 determines that the data package should be distributed to the health care professional's personal contact addresses, and generates an alert data package to health care professional's personal profile MIX node 314. MIX node 314 distributes multiple alert message data packages 316,318—one alert to MIX node 320 which is running within the health care provider mobile phone 322. MIX node 320 triggers an alert on the phone 322. MIX node 314 transmits data package 318 to the health care provider's TV Set Top Box 320 to be displayed immediately as an alert on a digital TV.

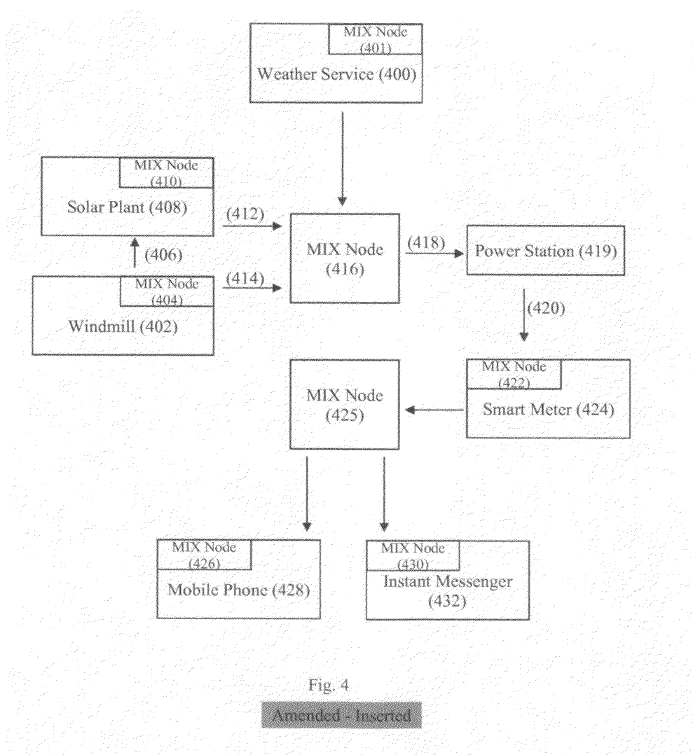

FIG. 4 illustrates a flow of communication according to an embodiment. Weather service 400, windmill 402 and solar plant 408 are running MIX nodes 401,404,410 respectively. MIX nodes 401,404,410 are configured by meta-data to distribute data packages to MIX node 416. Processing instructions in MIX node 416 collect the data packages and generates an enriched data package 418 with combined weather, windmill and solar plant information, which it is configured to distribute to a system at power station 419. Power station 419 transmits a request to MIX node 422 embedded in smart meter 424, instructing smart meter 424 to change the price of electricity. MIX node 422 in smart meter 424 is configured by meta-data to send a data package to MIX node 425 which is configured to distribute home alerts. MIX node 425 distributes data packages to MIX nodes 426,430 in mobile phone 428 and instant messenger client 432 respectively.

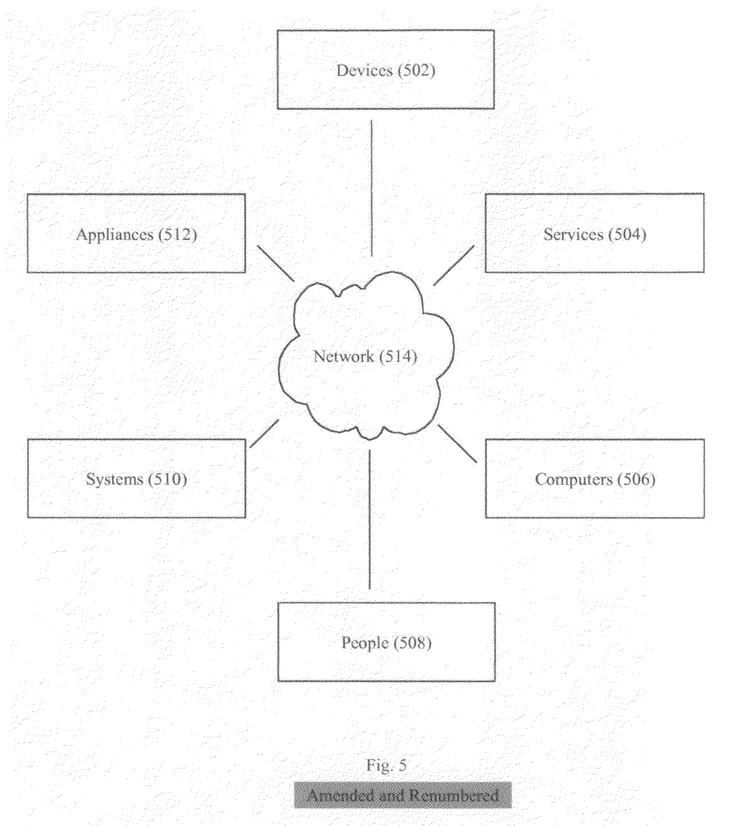

FIG. 5 illustrates an embodiment in which multiple entity types are integrated via meshed information exchange network 514. Entities include devices 502, services 504, computers 506, people 508, systems 510, appliances 512.

Meshed information exchange network 414 creates a virtual space where all are interconnected and interact in real-time.

A meshed information exchange network has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

What is claimed is:

1. A method for entities to communicate through a meshed information exchange (MIX) node comprising:
associating an entity with a MIX node, the node comprising at least one of entity attributes, unique identifiers, receiving adapters, processing instructions, node meta-data, data storage, delivery adapters;
executing the MIX node in at least one data processing system comprising at least one memory for storing instructions and at least one processor for executing said instructions;
processing a data package within the MIX node according to at least one of processing instructions, node meta-data;
obtaining the address of at least one receiver according to at least one of processing instructions, node meta-data, potential recipient's meta-data;
obtaining a delivery adapter that can deliver data to the receiver's address type according to at least one of processing instructions, node meta-data;
transmitting a data package to at least one receiver MIX node using a delivery adapter.

2. The method for entities to communicate through a meshed information exchange node of claim 1, wherein the entity attributes comprise of data structures that model information characteristic of the types of entity associated with a node and wherein these attributes change as entity state changes.

3. The method for entities to communicate through a meshed information exchange node of claim 2 wherein the type of entity associated with a node is among the group of entities that includes but is not limited to a person, an organization, a consumer appliance, a service, a mobile device, a computer, a manufactured product, or other distinct entity.

4. The method for entities to communicate through a meshed information exchange node of claim 1, wherein the entity attributes are structured in the form of a format in the group of structured data including Extensible Markup Language (XML), Hypertext Markup Language (HTML), tagged data.

5. The method for entities to communicate through a meshed information exchange node of claim 1, wherein the unique identifier of a node is in the form of a Uniform Resource Locator (URL), or Extensible Resource Identifier (XRI), or an Internet Domain Name, or an Internet Protocol Address, or other unique name that can be resolved to a unique network address.

6. The method for entities to communicate through a meshed information exchange node of claim 5, wherein the URL, or XRI, contains a path expression that names the node hierarchically so that it is grouped with other related entity nodes.

7. The method for entities to communicate through a meshed information exchange node of claim 1, wherein one or more receiving adapters are selected from a group of data transfer protocols including but not limited to hypertext transport protocol, email transport protocol, short message service transport protocol, instant messaging transport protocol, simple object access protocol, TCP/UDP, inter-process communication, operating system call, hardware data transfer.

8. The method for entities to communicate through a meshed information exchange node of claim 1, wherein processing instructions comprise at least one of the formats of compiled code, byte-code, script, virtual machine instructions, interpreter instructions, instructions defined in Extensible Markup Language (XML).

9. The method for entities to communicate through a meshed information exchange node of claim 1, wherein processing instructions integrate with, or are a part of other software running on the system hosting the node, or accessible by the node.

10. The method for entities to communicate through a meshed information exchange node of claim 1, wherein processing instructions are retrieved from another node, or from another network endpoint.

11. The method for entities to communicate through a meshed information exchange node of claim 1, wherein processing instructions includes accessing or modifying components of the node including but not limited to entity attributes, unique identifiers, receiving adapters, processing instructions, data storage area, delivery adapters, node meta-data.

12. The method for entities to communicate through a meshed information exchange node of claim 1, wherein processing instructions are selectively executed depending on components of the node including but not limited to entity attributes, data storage area, node meta-data.

13. The method for entities to communicate through a meshed information exchange node of claim 1, wherein node meta-data comprises at least one of: information that describes the node's resource and capabilities, information that describes the network location of other meshed information exchange nodes, information that controls the node's functional behavior, information that the node uses for security and authentication and authorization.

14. The method for entities to communicate through a meshed information exchange node of claim 13, wherein resource and capabilities definitions comprise information that specify the resources and capabilities of the node, including but not limited to entities that the node is associated with, the information the node provides, the capabilities the node supports, the services the node offers, and other information about the node that may be discovered by others.

15. The method for entities to communicate through a meshed information exchange node of claim 14, wherein resource and capabilities definitions are described by structured data, such as Extensible Markup Language (XML), or an Internet-standard resource definition format such as Extensible Resource Descriptor Sequence (XRDS).

16. The method for entities to communicate through a meshed information exchange node of claim 14, wherein resource and capabilities definitions are described using Hypertext Transport Markup Language (HTML or XHTML).

17. The method for entities to communicate through a meshed information exchange node of claim 14, wherein resource and capabilities definitions are requested by, and transmitted in part or in full to another node, or another network endpoint.

18. The method for entities to communicate through a meshed information exchange node of claim 14, wherein resource and capabilities definitions are also stored at a service provider in such a way that nodes may be registered, searched and discovered through that service provider.

19. The method for entities to communicate through a meshed information exchange node of claim 13, wherein information that describes the network location of other meshed information exchange nodes comprises the address of other nodes.

20. The method for entities to communicate through a meshed information exchange node of claim 19, wherein the address of other nodes includes the address of at least one default distribution node.

21. The method for entities to communicate through a meshed information exchange node of claim 13, wherein information that controls the node's functional behavior includes but is not limited to: access control instructions, data package distribution instructions, selective processing instructions, commercial transaction instructions.

22. The method for entities to communicate through a meshed information exchange node of claim 21, wherein commercial transaction instructions include instructions that selectively execute payment or credit or debit transactions in the course of the node's execution.

23. The method for entities to communicate through a meshed information exchange node of claim 13, wherein information that the node uses for security and authentication and authorization includes but is not limited to authentication instructions, authorization instructions, security tokens, security credentials, passwords, secure PINs, digital certificates.

24. The method for entities to communicate through a meshed information exchange node of claim 1, wherein the data storage of a node is at least one of memory for storing data, removable media for storing data, fixed media for storing data.

25. The method for entities to communicate through a meshed information exchange node of claim 1, wherein the data storage of a node is used to store at least one in the group of: data that is owned by the node, generated by the node, received by the node, generated by an entity that the node is associated with.

26. The method for entities to communicate through a meshed information exchange node of claim 1, wherein the data storage of a node is used to hold data that the node has to transmit to another node or network endpoint in order to properly time a message, or if the recipient is temporarily unreachable or unavailable in order to achieve fault tolerance.

27. The method for entities to communicate through a meshed information exchange node of claim 1, wherein one or more delivery adapters are selected from a group of data transfer protocols including but not limited to hypertext transport protocol, email transport protocol, short message service transport protocol, instant messaging transport protocol, simple object access protocol, TCP/UDP, inter-process communication, operating system call, hardware data transfer.

28. The method for entities to communicate through a meshed information exchange node of claim 1, wherein executing the MIX node in at least one data processing system comprises executing the node with a default HTTP/HTTPS receiver, so that the node can interact and be accessed over web protocols.

29. The method for entities to communicate through a meshed information exchange node of claim 1, wherein executing the MIX node in at least one data processing system comprises executing the node inside a data processing system that is associated with an entity that the node represents.

30. The method for entities to communicate through a meshed information exchange node of claim 29, wherein a data processing system that is associated with an entity that the node represents includes but is not limited to mobile phones, smart phones, consumer products, home appliances, computers, personal communications devices, medical devices, services, infrastructure, machines.

31. The method for entities to communicate through a meshed information exchange node of claim 29, wherein executing the node further includes creating an adapter interface between the node processing instructions and data storage and the host system, so that the node can control the system and software on the system, and the system and its software can use the node.

32. The method for entities to communicate through a meshed information exchange node of claim 30, wherein infrastructure includes electrical grid infrastructure, so that the node can communicate critical information about the electrical system, interact with people and other systems, and thus help to implement a “smart electricity grid”.

33. The method for entities to communicate through a meshed information exchange node of claim 1, wherein a data package is structured data in the format of at least one in the group of: Extensible Markup Language (XML), Hypertext Markup Language (HTML/XHTML), text.

34. The method for entities to communicate through a meshed information exchange node of claim 1, wherein a data package is binary data.

35. The method for entities to communicate through a meshed information exchange node of claim 1, wherein a data package comprises at least one of data package meta-data, and a payload.

36. The method for entities to communicate through a meshed information exchange node of claim 35, wherein the data package meta-data comprises at least one of data package identifier, payload attributes, source identification, security credentials, addressing information and other information for the secure and successful delivery and fulfillment of the data package.

37. The method for entities to communicate through a meshed information exchange node of claim 35, wherein the data package meta-data further comprises a Multipurpose Internet Mail Extensions (MIME) description.

38. The method for entities to communicate through a meshed information exchange node of claim 35, wherein the data package payload comprises at least one of binary data, text data.

39. The method for entities to communicate through a meshed information exchange node of claim 1, wherein processing a data package comprises generating a data package inside the node.

40. The method for entities to communicate through a meshed information exchange node of claim 39, wherein generating a data package inside the node includes incorporating in the package at least one of data generated by the processing instructions of the node, data in the data storage of the node, data acquired from a system that hosts the node.

41. The method for entities to communicate through a meshed information exchange node of claim 39, wherein generating a data package inside the node includes incorporating in the package at least one of a reference to data generated by the processing instructions of the node, a reference to data in the data storage of the node, a reference to data acquired from a system that hosts the node, a reference to other data that may be acquired over a network by standard protocols.

42. The method for entities to communicate through a meshed information exchange node of claim 1, wherein processing a data package comprises receiving a data package that originated outside the node.

43. The method for entities to communicate through a meshed information exchange node of claim 42, wherein receiving a data package from outside the node triggers the processing instructions of the node.

44. The method for entities to communicate through a meshed information exchange node of claim 43, wherein triggering the processing instructions of the node comprises launching a handler application or software that uses at least one of: data in the data package, data referenced by the data package.

45. The method for entities to communicate through a meshed information exchange node of claim 42, wherein receiving a data package further comprises modifying the data package.

46. The method for entities to communicate through a meshed information exchange node of claim 42, wherein receiving a data package ,further comprises transmitting the data package to at least one of: another node, another network endpoint.

47. The method for entities to communicate through a meshed information exchange node of claim 42, wherein receiving a data package further comprises decrypting all or part of the data package.

48. The method for entities to communicate through a meshed information exchange node of claim 1, wherein obtaining the address of at least one receiver includes reading instructions in the node's meta-data including, but not limited to distribution instructions.

49. The method for entities to communicate through a meshed information exchange node of claim 1, wherein obtaining the address of at least one receiver includes reading meta-data in a data package including, but not limited to addressing information.

50. The method for entities to communicate through a meshed information exchange node of claim 1, wherein obtaining the address of at least one receiver includes selecting the most appropriate receiving node using at least one of: node processing instructions, node meta-data, meta-data of the delivery candidates.

51. The method for entities to communicate through a meshed information exchange node of claim 1, wherein obtaining the address of at least one receiver includes selecting a default distribution node from the node meta-data.

52. The method for entities to communicate through a meshed information exchange node of claim 1, wherein one or more delivery adapters are selected from a group of data transfer protocols including but not limited to hypertext transport protocol, email transport protocol, short message service transport protocol, instant messaging transport protocol, simple object access protocol, TCP/UDP, inter-process communication, operating system call, hardware data transfer.

53. The method for entities to communicate through a meshed information exchange node of claim 1, wherein transmitting a data package includes updating a node address in the addressing meta-data of the data package.

54. The method for entities to communicate through a meshed information exchange node of claim 1, wherein transmitting a data package further includes encrypting all or part of the data package.

55. The method for entities to communicate through a meshed information exchange node of claim 1, wherein transmitting a data package further includes the node's processing instructions acquiring authorization tokens or credentials in order to access the transmission receiver.

56. The method for entities to communicate through a meshed information exchange node of claim 55, wherein acquiring authorization tokens or credentials includes executing Internet standard authentication and authorization protocols, including OAUTH or SAML.

57. The method for entities to communicate through a meshed information exchange node of claim 55, wherein acquiring authorization tokens or credentials further includes caching these tokens or credentials for repeated use.

58. A method for entities to communicate through a network of meshed information exchange (MIX) nodes comprising;
installing suitably configured MIX nodes on systems that are associated with entities;
adapting software on systems to MIX nodes' receiving and delivery adapters;
registering MIX node addresses with a service provider;
configuring MIX nodes to connect them to other nodes and to network endpoints;
publishing data to MIX nodes;
consuming data from MIX nodes;

59. The method for entities to communicate through a network of meshed information exchange nodes of claim 58, wherein the input of a node may be linked to the outputs of one or more other nodes such that new data packages composed of information mixed from separate sources can be assembled in real-time.

60. The method for entities to communicate through a meshed information exchange node of claim 58, wherein the MIX network is used to deliver services including but not limited to consumer media content, social networking information, identity information, medical devices information, infrastructure information, digital payments, commercial transactions, communications, instrumentation.

61. The method for entities to communicate through a meshed information exchange node of claim 58, wherein part or all of a data package is processed using data encryption techniques as it passes in transit through one or more MIX nodes in the network, so as to provide guaranteed auditing of the pathways that information transits.

62. The method for entities to communicate through a meshed information exchange node of claim 58, wherein a “distributed digital contract pathway” is assembled so that a data package transits sequentially or in parallel through a group of MIX nodes, whereupon each node signs or modifies a portion of the data package until the data package reaches a destination node—so that the destination node can affirm multi-party authorization or consent, among a distributed group of participants, in real-time.

63. The method for entities to communicate through a meshed information exchange node of claim 58, wherein consuming data from a MIX node includes the ability of an entity to publicize only a MIX node URI, following which, information published to the entity's MIX node is dynamically distributed to email, phone number, or other destinations—thus allowing the entity to receive communications at the most favorable locations, and to keep selective contact information private.

64. The method for entities to communicate through a meshed information exchange node of claim 58, wherein a consumer of data from a publishing MIX node publishes a subscription request message (data package) to the node, containing information about the subscription details, wherein the publishing node's processing instruction adds the consumer's information to its addressing meta-data and distribution instructions.

65. The method for entities to communicate through a meshed information exchange node of claim 58, wherein consuming data from a MIX node includes communicating with that node using other software that performs one or both of: processing the type of data that the node delivers, transferring data with the MIX node via a protocol that is implemented by a receiving adapter of the node.
